(19) United States
(12) Patent Application Publication
(10) Pub. No.: US 2017/0052705 A1
(43) Pub. Date: Feb. 23, 2017

(54) LISTING STORAGE MEDIA

(71) Applicant: International Business Machines Corporation, Armonk, NY (US)

(72) Inventors: Tohru Hasegawa, Tokyo (JP); Masayuki Iwanaga, Urayasu-si (JP)

(21) Appl. No.: 14/828,578

(22) Filed: Aug. 18, 2015

(51) Int. Cl. G06F 3/06; G06F 17/30

(52) U.S. Cl. CPC G06F 3/0605; G06F 3/0631; G06F 3/0686; G06F 17/30182

(57) ABSTRACT

A directory listing for use with a file system for a storage media library including a plurality of storage drives and a plurality of storage mediums, where all of the storage mediums are respectively either mounted on a storage drive or unmounted with respect to the storage drives, at least one storage medium is mounted on a storage drive, at least one storage medium is unmounted with respect to the storage drives. In the directory listing the mounted storage medium(s) are not intermingled with the unmounted storage medium(s). In some embodiments the storage media library system is a tape media library system where the storage mediums are tape mediums and the storage drives are tape drives.

### BACKGROUND

The present invention relates to listing storage media, and more specifically, to listing storage media in a file system for a storage media library in human readable form and format.

It is conventional to display to a user a list of tape media (sometimes herein referred to as “mediums”) in a tape media storage system. This may be called a directory listing at the system level. The directory listing of tape mediums may, or may not, further include nested lists of the files stored on each tape medium in the directory listing. A directory list of tape mediums is typically ordered in some manner, such as alphabetically or by date of a time stamp associated with the tape medium. Typically, some of the tape mediums in the list will be currently mounted, and others will not be currently mounted. These mounted and unmounted drives are typically intermingled in a directory listing of tape mediums.

### SUMMARY

According to an aspect of the present invention, there is a method, computer program product and/or system for use with a file system for a storage media library including a plurality of storage drives and a plurality of storage mediums, where all of the storage mediums are respectively either mounted on a storage drive or unmounted with respect to the storage drives, at least one storage medium is mounted on a storage drive, at least one storage medium is unmounted with respect to the storage drives, that performs the following operations (not necessarily in the following order): (i) determining a set of mounted storage medium(s) of the plurality of storage mediums that are respectively mounted on a storage drive; (ii) determining a set of unmounted storage medium(s) of the plurality of storage mediums that are respectively unmounted with respect to the storage drive; and (iii) generating a machine readable display data set corresponding to a directory listing of the plurality of storage mediums where the set of mounted storage medium(s) are not intermingled with the set of unmounted storage medium(s) in the directory listing.

### BRIEF DESCRIPTION OF THE DRAWINGS

FIG. 1 depicts an example of a directory structure of a tape medium.

FIG. 2 depicts an example of a directory structure of a tape library.

FIG. 3 depicts an example of a batch file for copying directories from a tape library to a hard disk.

FIG. 4 depicts an example of tape media listed on the basis of inventory information.

FIG. 5 depicts a block diagram of a tape library system according to some embodiments of the present invention.

FIG. 6 depicts an example of a hardware configuration of a computer able to implement some embodiments of the present invention.

FIG. 7 depicts an example of a tape media management table according to some embodiments of the present invention.

FIG. 8 depicts a flowchart representing an operation of a tape media management logic according to some embodiments of the present invention.

FIG. 9 depicts an example of a media directory table according to some embodiments of the present invention.

FIG. 10 depicts a flowchart representing an operation of a media directory listing logic according to some embodiments of the present invention.

FIG. 11 depicts an example of a screen as a result of an operation of a media directory listing logic according to some embodiments of the present invention.

### DETAILED DESCRIPTION

According to an embodiment of the present invention, there is provided a computer-implemented method for listing storage media, in a file system for a storage media library including N storage drives (where N is an integer not less than 1) and M storage media (where M is an integer greater than N). The method includes listing K storage media (where K is an integer not less than 1 and less than M) mounted on any of the N storage drives, out of the M storage media. The method includes listing (M−K) storage media not mounted on any of the N storage drives, out of the M storage media, apart from the K storage media mounted on any of the N storage drives. The word “distinctively” is sometimes used herein to describe situations making a listing that is separate and apart from other listings (for example, two subset listings that both draw members from a larger set).

According to another embodiment of the present invention, there is provided an apparatus for listing storage media, in a file system for a storage media library including N storage drives (where N is an integer not less than 1) and M storage media (where M is an integer greater than N). The apparatus includes a processor and a memory coupled to the processor. The memory includes instructions. When executed by the processor, the instructions cause the processor to list K storage media (where K is an integer not less than 1 and less than M) mounted on any of the N storage drives, out of the M storage media. When executed by the processor, the instructions cause the processor to list (M−K) storage media not mounted on any of the N storage drives, out of the M storage media, distinctively from the K storage media mounted on any of the N storage drives.

According to yet another embodiment of the present invention, there is provided a computer program product for listing storage media, in a file system for a storage media library including N storage drives (where N is an integer not less than 1) and M storage media (where M is an integer greater than N). The computer program product includes a computer readable storage medium having program instructions embodied with the computer readable storage medium. The program instructions are executable by a processor to cause the processor to list K storage media (where K is an integer not less than 1 and less than M) mounted on any of the N storage drives, out of the M storage media. The program instructions are executable by a processor to cause the processor to list (M−K) storage media not mounted on any of the N storage drives, out of the M storage media, distinctively from the K storage media mounted on any of the N storage drives.

Hereinafter, some embodiments of the present invention will be described in detail with reference to the attached drawings. It is to be noted that the present invention is not limited to these some embodiments to be given below and may be implemented with various modifications within the scope of the present invention. In addition, the drawings used herein are for purposes of illustration, and may not show actual dimensions.

The Linear Tape File System Single Drive Edition (LTFS SDE) is a file system for a single tape drive, and the Linear Tape File System Library Edition (LTFS LE) is a file system for a tape library. Because both file systems record data on tape media in conformity to a Linear Tape File System (LTFS) format, which is an industry standard format, data written on tape media by LTFS SDE can be read or updated by LTFS LE. For this reason, by being physically conveyed to a tape library and by being inserted therein, multiple tape media each created by LTFS SDE become accessible by LTFS LE. Thus, data scattered throughout the multiple tape media may be gathered up in one place.

Because LTFS SDE and LTFS LE are file systems, they can facilitate access tape media in a manner similar to that used to access data on non-tape media, such as hard disk media, USB (universal serial bus) media, or the like. These file systems have been started to be used to organize and control archiving video data of monitoring cameras or broadcast contents. This archiving of video data in the form of files is an application for which tape media have not been conventionally used.

The following description is given by taking, as an example, a monitoring camera system which records video data from multiple monitoring cameras using LTFS SDE and archives the video data in a tape library using LTFS LE. Note that, in the following description: (i) the phrase “insert a tape medium in a tape library” indicates placing a tape cartridge having a tape medium in a rack in a tape library; (ii) the phrase “load a tape medium to a tape drive” indicates putting a tape cartridge having a tape medium in a tape drive with no access to the tape medium; and (iii) the phrase “mount a tape medium on a tape drive” indicates preparing, after putting a tape cartridge having a tape medium in a tape drive, for an access to the tape medium, such as caching meta-information described below.

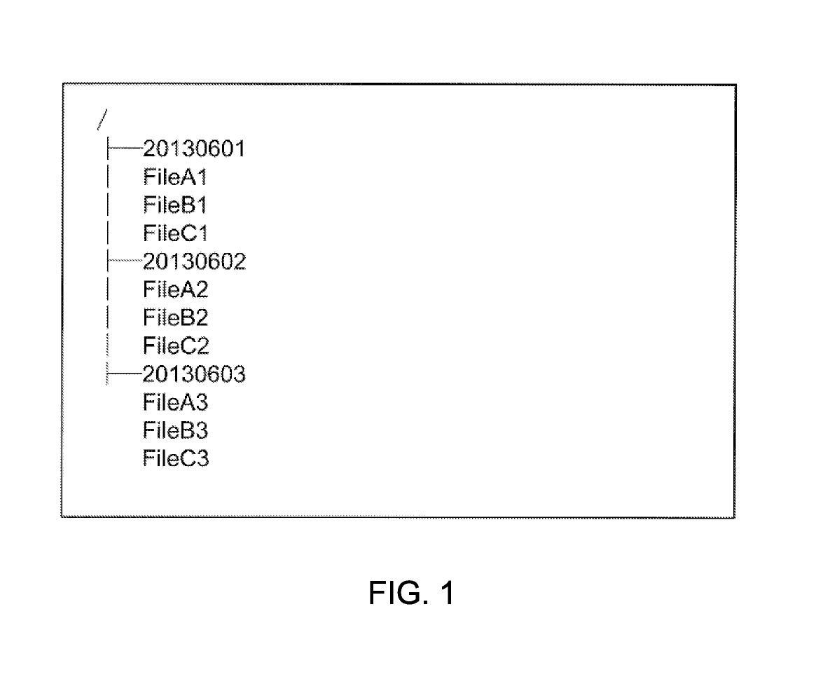

To record video data from a monitoring camera, the monitoring camera system may create directories each representing a date, and may record the video data in the form of multiple divided files in a directory representing the date when the video data is captured. Referring to FIG. 1, there is shown an example of a directory structure of a tape medium. As shown in the figure, directories each representing a date (hereinafter referred to as “date directories”) are present in the tape medium, and the video data is stored as files in the corresponding date directories. In FIG. 1, directories “20130601”, “20130602” and “20130603” are the date directories, and, for example, files “File A1”, “File B1”, and “File C1” are the files including the video data captured on 2013/06/01.

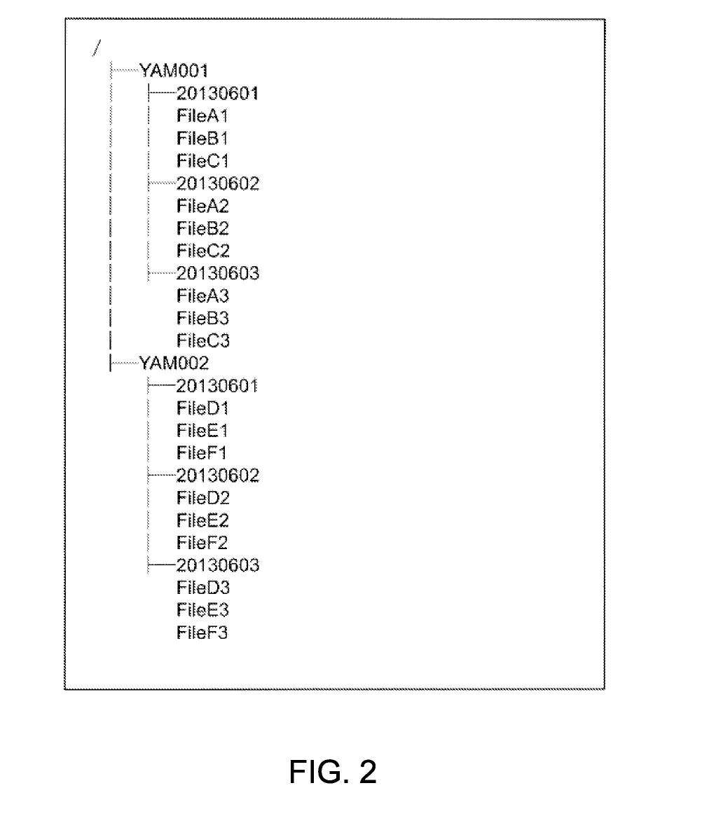

Referring to FIG. 2, there is shown an example of a directory structure of the tape library. LTFS LE may create, for all tape media inserted in the tape library, directories each representing a media name encoded in a bar code attached to a tape medium (hereinafter referred to as “media directories”), and may place files and directories on a tape medium, under a media directory corresponding to a media name of the tape medium. In FIG. 2, directories “YAM001” and “YAM002” are the media directories. It is assumed that a tape medium “YAM001” having the directory structure shown in FIG. 1, and a tape medium “YAM002” are inserted in the tape library. Also, it is assumed that the tape medium “YAM002” has, for example, a directory “20130601” including files “FileD1”, “FileE1” and “FileF1” instead of files “FileA1”, “FileB1” and “FileC1” in the tape medium “YAM001”.

In the monitoring camera system, the archived video data from the monitoring cameras may be viewed in a highly selective manner with respect to which portions of the video of the video files are viewed (for example, only viewing the relatively small portions of the videos that show crimes). Specifically, on the occurrence of an event, the monitoring camera system may seek, in all tape media under LTFS LE, date directories representing the date when the event occurs, and may copy the date directories to a hard disk. As a result, the archived video data can be utilized.

LTFS LE caches meta-information of files in all the tape media ever mounted on any tape drive in the tape library, for example, in a memory. The meta-information may include the names of the files, the time stamps of the files, and the like. To cache the meta-information of the files in all the tape media, all the tape media need to have been mounted a tape drive at least once. This is easily satisfied by mounting a tape medium on a tape drive at the time when the tape medium is first inserted in the tape library. Only when making an access to the bodies of the files, such as creating the files, updating the files, and reading the files, LTFS LE instructs the tape library to load, mount, and access the tape media corresponding to the files. As a consequence, the tape media are not loaded to a tape drive when LTFS LE is requested to list the names of the files stored in the tape media using a “dir” command or the like. The tape media are loaded to and mounted on a tape drive only when LTFS LE is requested to read or update the files.

For this reason, when the aforementioned event occurs, LTFS LE need not instruct the tape library to mount tape media having date directories representing the date when the event occurs, on any of the tape drives. LTFS LE only has to seek the meta-information in the memory to find the date directories. More specifically, on the occurrence of the event, the date directories representing the date when the event occurs in all the tape media under the control of LTFS LE can be copied to a hard disk by using a simple batch file.

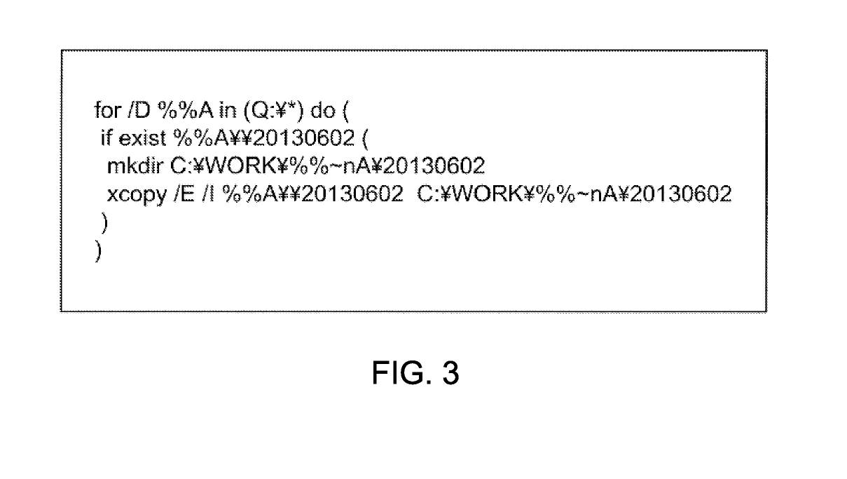

Referring to FIG. 3, there is shown an example of the batch file. When the batch file is run, LTFS LE may execute a processing including three steps described below.

The first step is to list media directories directly under the root directory of the “Q” drive in Windows (RTM). It is assumed that LTFS LE is assigned to the “Q” drive.

The second step is to check whether or not a date directory “20130602” is present under each of the media directories.

The third step is to, if the date directory “20130602” is present under a media directory, create a directory corresponding to the media directory under the directory “C: \work”, and copy the date directory “20130602” from the media directory to the created directory.

In the above processing, the date directories “20130602” are copied in the order in which the media directories are listed by LTFS LE at the first step.

The order in which a file system lists files and directories depends on the type of the file system and is not particularly specified. For example, the NT File System (NTFS) lists files and directories in alphabetical order, and the File Allocation Table 32 (FAT32) lists files and directories in order of date and time of creation.

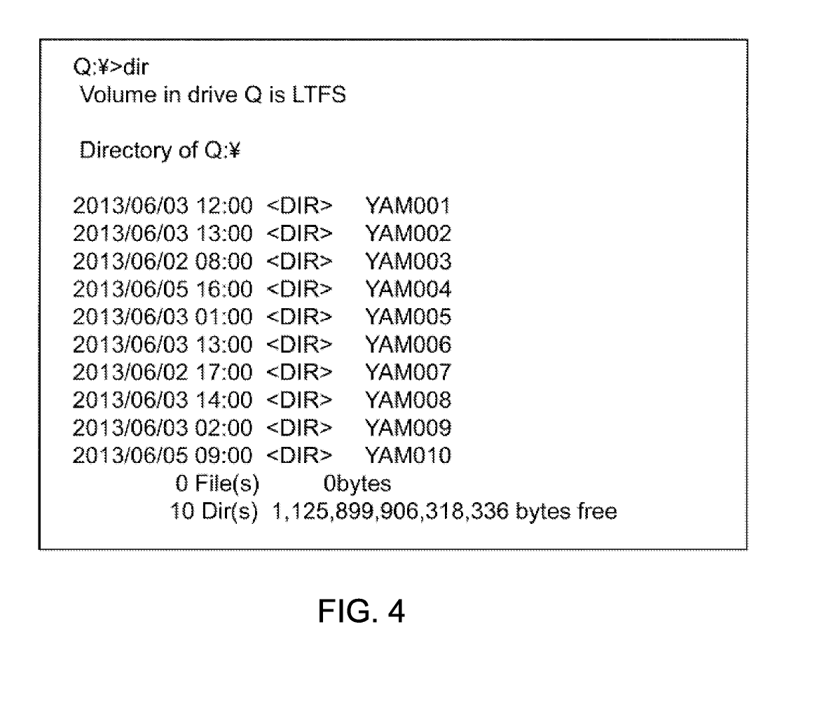

LTFS LE lists media directories in the order in which the media directories are registered in the inventory information. The inventory information indicates configuration of the tape library, including the tape media and the tape drives in the tape library. LTFS LE acquires the inventory information from the tape library when the LTFS LE is activated, when a tape medium is added to the tape library, or the like. Referring to FIG. 4, there is shown an example of media directories listed on the basis of the inventory information by LTFS LE. In FIG. 4, it is assumed that ten tape media (“YAM001” to “YAM010”) are inserted in the tape library and the tape library provides the inventory information in which the tape media “YAM001” to “YAM010” are placed in this order. In this case, the media directories are listed as shown in FIG. 4, in response to a “dir” command.

In this example, when the batch file of FIG. 3 is run, LTFS LE checks whether or not the date directory “20130602” is present in the media directories, and if the date directory is present in the media directories, the date directory is copied from the media directories to a hard disk, in order from the media directory “YAM001” to the media directory “YAM010”. More specifically, if the date directory “20130602” is present in the media directories “YAM001” and “YAM002”, the date directory “20130602” under the media directory “YAM001” is copied, and then the date directory “20130602” under the media directory “YAM002” is copied.

In LTFS LE, although the meta-information of files is cached in the memory, a tape medium needs to be mounted on a tape drive to read the files therein. Therefore, the files are copied when the tape medium storing the files is mounted on a tape drive.

Furthermore, in LTFS LE, after an access to the tape medium mounted on the tape drive is finished, the tape medium is not immediately unmounted from the tape drive, but is kept being mounted on the tape drive. When another tape medium is requested to be accessed, such another tape medium is mounted on another tape drive if available. This is because it is experimentally known that a tape medium is likely to be accessed again immediately after the tape medium is accessed. Specifically, such another tape drive to be used is selected in accordance with an LRU-based algorithm.

Generally, the number of tape drives in the tape library is smaller than the number of tape media inserted in the tape library. When LTFS LE makes a response to a certain amount of access requests to tape media, all the tape drives end up being occupied with the tape media mounted thereon. Thus, if a tape medium to be accessed is not mounted on any tape drive, another tape medium already mounted on a tape drive is unmounted from the tape drive, and then the tape medium to be accessed is mounted on the tape drive. As a result, response time to an access request differs depending on whether or not a tape medium to be accessed is already mounted on any tape drive.

When multiple tape media are successively accessed, mounting and unmounting may be repeated depending on the order of accesses to the multiple tape media, which may cause a problem of the response time being longer than necessary. A case will be discussed below in which a tape medium “YAM001” is not mounted on any tape drive and a tape medium “YAM002” is mounted on any tape drive. In this case, to copy a date directory “20130602” in the tape medium “YAM001”, the tape medium “YAM001” needs to be mounted on any tape drive. If a tape drive, on which the tape medium “YAM002” is already mounted, is selected in accordance with the LRU-based (that is, least recently used based) algorithm, the following operation may be performed. That is, unmount of the tape medium “YAM002”, mount of the tape medium “YAM001”, copy of the date directory from the tape medium “YAM001”, unmount of the tape medium “YAM001”, mount of the tape medium “YAM002”, and copy of the date directory from the tape medium “YAM002” may be performed in this order. Because the tape medium “YAM002” is once unmounted and then the tape medium “YAM002” is mounted again, as described above, completing a series of copy processing takes a longer time than it could under some embodiments of the present invention.

In the above example, the problem in the situation in which video data is archived from monitoring cameras has been described in particular. In examples other than the above example, LTFS LE often backs up or archives data by using a batch file attached to OS as described before. Thus, the problem occurs not only in the situation in which the video data is archived from monitoring cameras but also in the situation in which general data is backed up or archived.

To avoid the above problem, in these some embodiments, LTFS LE lists the media directories in the order in which the media directories corresponding to the mounted tape media are prioritized.

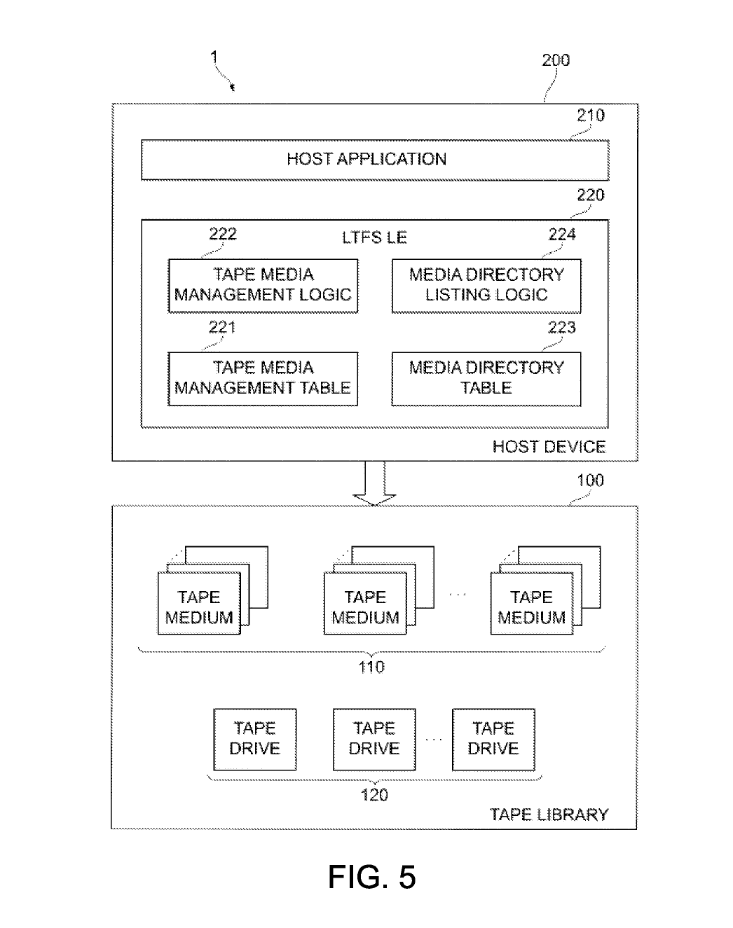

Referring to FIG. 5, there is shown a block diagram of a tape library system 1 to which the some embodiments are applied. As shown in the figure, the tape library system 1 may include a tape library 100 as one example of a storage media library and a host device 200.

The tape library 100 may include a set of tape media 110 as one example of storage media and a set of tape drives 120 as one example of storage drives. The set of the tape media 110 may include multiple tape media, and the set of the tape drives 120 may include at least one tape drive. In other words, the set of the tape drives 120 may include N tape drives (where N is an integer not less than 1), and the set of the tape media 110 may include M tape media (where M is an integer greater than N). Each of the tape media 110 may be used for recording information, and may be housed in multiple tape cartridges respectively. Note that, as the set of the tape media 110, a set of magnetic tape media may be used. Also, each of the tape drives 120 writes multiple pieces of data transmitted from the host device 200 to the tape media 110, and reads multiple pieces of data to be transmitted to the host device 200 from the tape media 110.

The host device 200 may include one or more host applications 210 and LTFS LE 220 as one example of a file system. The host applications 210 may access the tape library 100 via LTFS LE 220. LTFS LE 220 may include a tape media management table 221, a tape media management logic 222, a media directory table 223 and a media directory listing logic 224. The tape media management table 221 may be a table stored in a memory of the LTFS LE 220, which shows mount states of the set of the tape media 110. The tape media management logic 222 may manage mount states of the set of the tape media 110 using the tape media management table 221. The media directory table 223 may be a table stored in a memory of the LTFS LE 220, which shows an order in which one or more tape media mounted on any tape drive have higher priority than one or more tape media not mounted on any tape drive. The media directory listing logic 224 may list media directories using the media directory table 223. In other words, the media directory listing logic 224 may list K tape media (where K is an integer not less than 1 and less than M) mounted on any of the N tape drives, out of the M tape media, and may list (M−K) tape media not mounted on any of the N tape drives, out of the M tape media. Specifically, the media directory listing logic 224 may list the (M−K) tape media, distinctively from the K tape media mounted on any of the N tape drives.

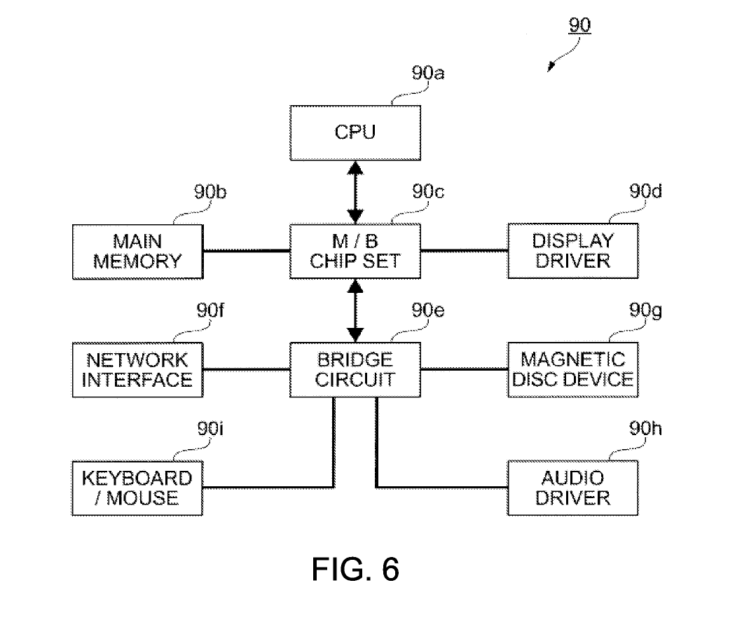

Referring to FIG. 6, there is shown an example of the hardware configuration of a computer 90 able to implement the some embodiments. As shown in the figure, the computer 90 may include a central processing unit (CPU) 90a serving as one example of a processor, a main memory 90b connected to the CPU 90a via a motherboard (M/B) chip set 90c and serving as one example of a memory, and a display driver 90d connected to the CPU 90a via the same M/B chip set 90c. A network interface 90f, magnetic disk device 90g, audio driver 90h, and keyboard/mouse 90i are also connected to the M/B chip set 90c via a bridge circuit 90e.

In FIG. 6, the various configurational elements are connected via buses. For example, the CPU 90a and the M/B chip set 90c, and the M/B chip set 90c and the main memory 90b are connected via CPU buses, respectively. Also, the M/B chip set 90c and the display driver 90d may be connected via an accelerated graphics port (AGP). However, when the display driver 90d includes a PCI express-compatible video card, the M/B chip set 90c and the video card are connected via a PCI express (PCIe) bus. Also, when the network interface 90f is connected to the bridge circuit 90e, a PCI Express may be used for the connection, for example. For connecting the magnetic disk device 90g to the bridge circuit 90e, a serial AT attachment (ATA), a parallel-transmission ATA, or peripheral components interconnect (PCI) may be used. For connecting the keyboard/mouse 90i to the bridge circuit 90e, a universal serial bus (USB) may be used.

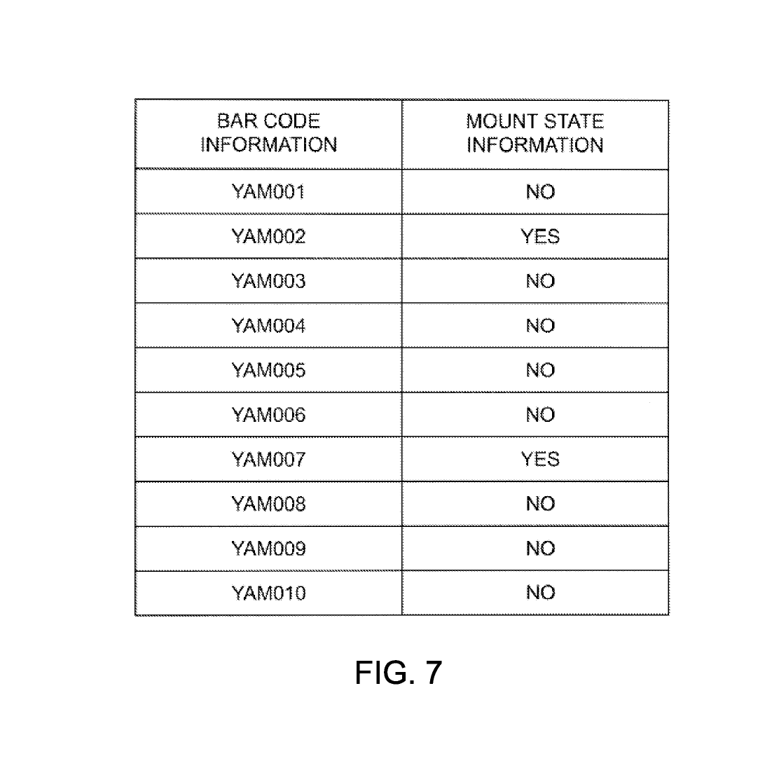

Referring to FIG. 7, there is shown an example of the tape media management table 221. The tape media management table 221 may contain bar code information as one example of an identifier and mount state information for each of the tape media 110. The bar code information may be, for example, a bar code string indicating a media name such as “YAM001”, “YAM002”, and the like, as shown in FIG. 7. The bar code string is encoded to and decoded from a bar code attached to a tape medium, for identifying the tape medium requested to be accessed, among the set of the tape media 110. The mount state information may be, for example, a mount state flag set to a “YES” state or a “NO” state, as shown in FIG. 7. The “YES” state indicates that the corresponding tape medium is mounted on any tape drive, and the “NO” state indicates that the corresponding tape medium is not mounted on any tape drive. Note that, in FIG. 7, it is assumed that tape media “YAM001” to “YAM010” are inserted in the tape library 100, and the tape media “YAM002” and “YAM007” are mounted on any of the tape drives 120.

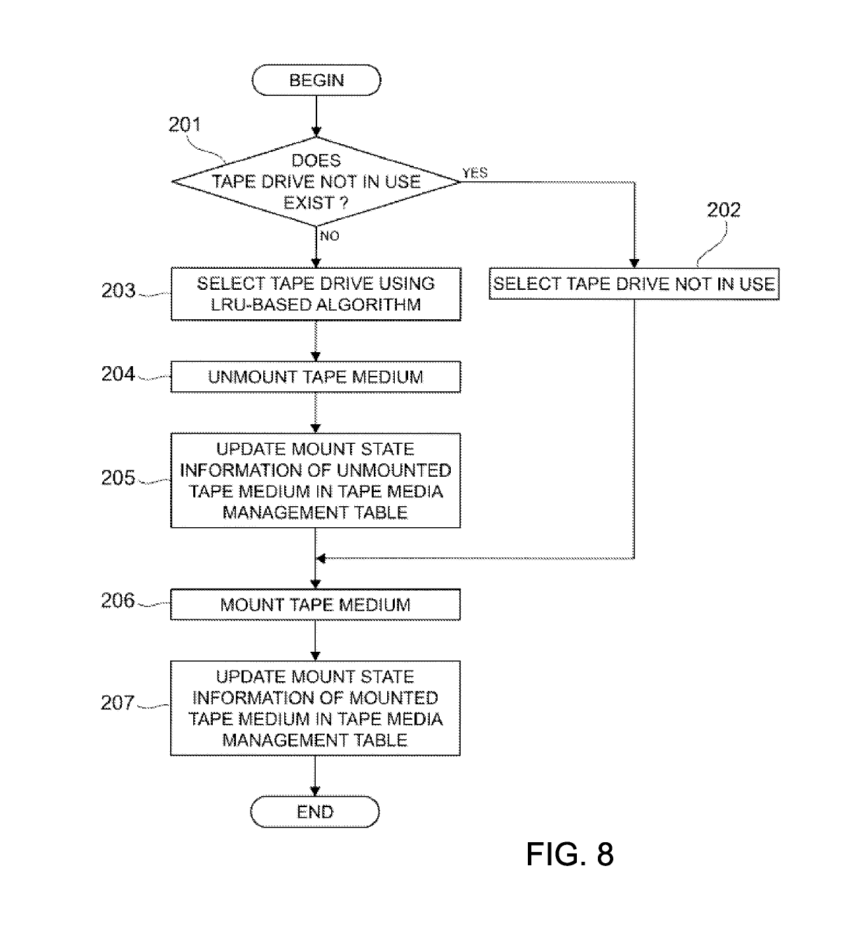

Referring to FIG. 8, there is shown a flowchart representing an example of an operation performed by the tape media management logic 222 when a tape medium is requested to be mounted on any tape drive in response to an access request to directories or files in the tape medium. Note that, in this flowchart, it is assumed that the tape medium requested to be mounted on any tape drive is initially not mounted on any tape drive.

As shown in the FIG. 8, the tape media management logic 222 determines whether or not a tape drive not in use exists among the set of the tape drives 120 (step 201). A phrase “a tape drive not in use” has the following possible, alternative meanings: (i) “a tape drive to which a tape medium is not loaded”; and (ii) “a tape drive to which a tape medium is loaded, but on which the tape medium is not mounted”. Such determination may be performed by reference to information about mount states of the set of the tape drives 120 in a memory of the LTFS LE 220, although the information is not shown in FIG. 8. If a tape drive not in use exists among the set of the tape drives 120, the tape media management logic 222 selects the tape drive not in use as a tape drive on which the tape medium is to be mounted (step 202).

If, at step 201, a tape drive not in use does not exist among the set of the tape drives 120, the tape media management logic 222 selects a tape drive using LRU-based algorithm among the set of the tape drives 120 (step 203). Specifically, the tape media management logic 222 may determine whether or not tape drives on which a tape medium having one or more unopened files or directories is mounted exist among the set of the tape drives 120. If such tape drives exist, the tape media management logic 222 may select a tape drive of which last access time is the oldest, out of such tape drives. If such tape drives do not exist, the tape media management logic 222 may select a tape drive of which last access time is the oldest, out of all the tape drives 120.

Next, the tape media management logic 222 unmounts the tape medium mounted on the selected tape drive, from the selected tape drive (step 204). Specifically, the tape media management logic 222 instructs the tape library 100 to unmount the tape medium. In response to the instruction, the tape library 100 unmounts the tape medium, and unloads the tape medium from the selected tape drive. Also, the tape media management logic 222 updates the mount state information of the unmounted tape medium in the tape media management table 221 (step 205). Specifically, the tape media management logic 222 updates the mount state flag to “NO”.

After the step 202 or step 205, the tape media management logic 222 mounts the tape medium requested to be mounted, on the selected tape drive (step 206). Specifically, the tape media management logic 222 instructs the tape library 100 to mount the tape medium on the selected tape drive. In response to the instruction, the tape library 100 loads the tape medium if necessary, and mounts the tape medium on the selected tape drive. Also, the tape media management logic 222 updates the mount state information of the mounted tape medium in the tape media management table 221 (step 207). Specifically, the tape media management logic 222 updates the mount state flag to “YES”.

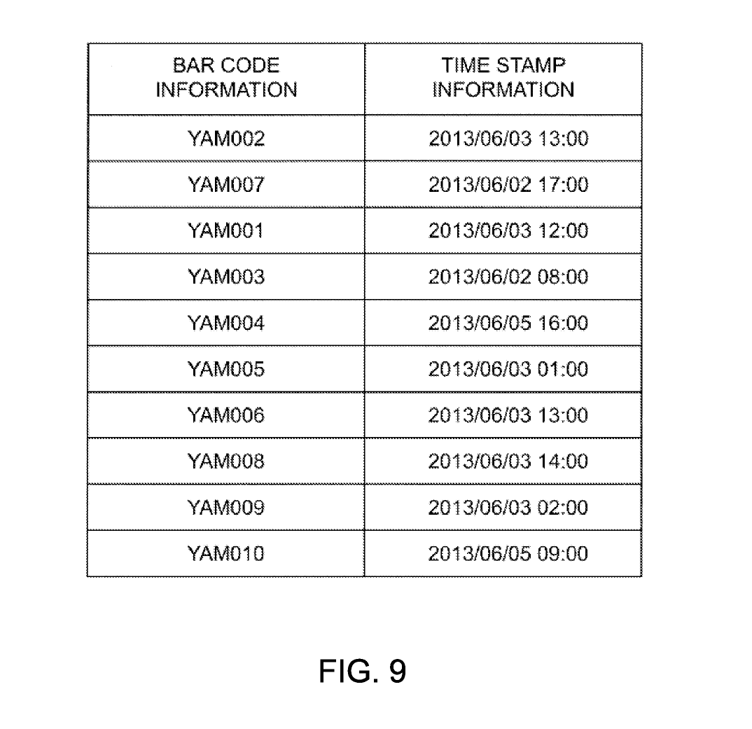

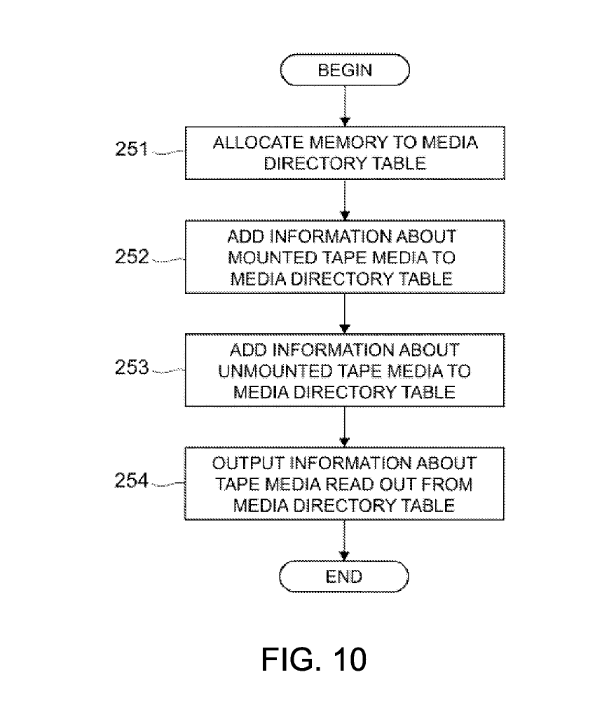

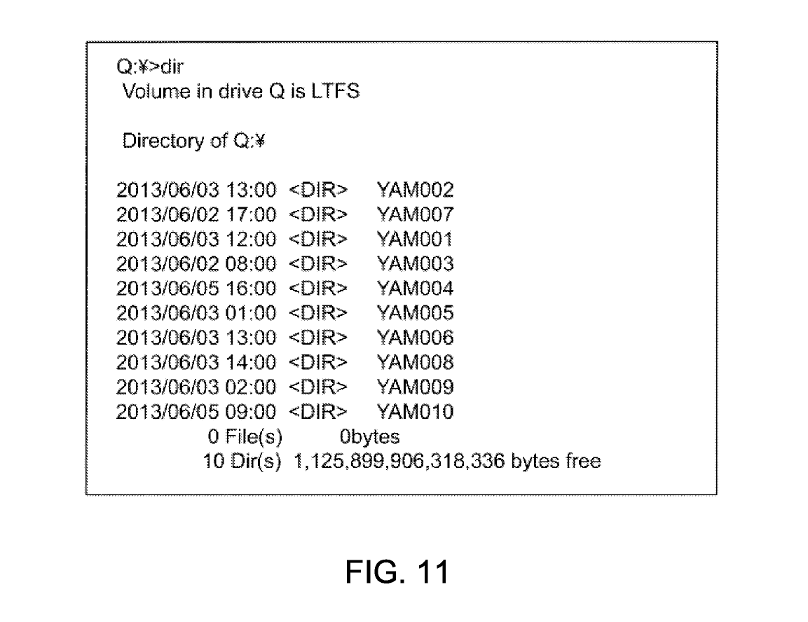

Referring to FIG. 9, there is shown an example of the media directory table 223. The media directory table 223 may contain bar code information and time stamp information for each of the tape media 110. The bar code information may be the same as is shown in FIG. 7. The time stamp information is an example of information to be listed by LTFS LE 220. In FIG. 9, it is assumed that the time stamp information is a date and time of the last update. This is because the date and time of the last update is to be listed in FIG. 11 below. The time stamp information is not limited to the above, and may be a date and time of any of creation, last access, change and the like. Note that the example shown in FIG. 9 indicates a resultant table after the operation of FIG. 10 described next. Before the operation of FIG. 10, the media directory table 223 is empty.

Referring to FIG. 10, there is shown a flowchart representing an example of an operation performed by the media directory listing logic 224 when response to a request to list media directories is made.

As shown in the figure, the media directory listing logic 224 allocates a memory of the LTFS LE 220 to the media directory table 223 (step 251). It is assumed that the media directory listing logic 224 empties all rows in the media directory table 223 at this point.

Next, the media directory listing logic 224 adds information about the mounted tape media as one example of a first storage medium in the set of the tape media 110 to the media directory table 223 (step 252). Specifically, the media directory listing logic 224 may read out the bar code information corresponding to the mount state information set to a “YES” state in the tape media management table 221 in order from top to bottom, and take out the time stamp information corresponding to the bar code information from the meta-information in the memory of the LTFS LE 220. After that, the media directory listing logic 224 may write the bar code information and the time stamp information to the media directory table 223, beginning at the top row.

Subsequently, the media directory listing logic 224 adds information about unmounted tape media as one example of a second storage medium in the set of the tape media 110 to the media directory table 223 (step 253). Specifically, the media directory listing logic 224 may read out the bar code information corresponding to the mount state information set to a “NO” state in the tape media management table 221 in order from top to bottom, and take out the time stamp information corresponding to the bar code information from the meta-information in the memory of the LTFS LE 220. After that, the media directory listing logic 224 may write the bar code information and the time stamp information to the media directory table 223, beginning at the row following the rows to which the bar code information and the time stamp information have been written at the step 252.

Finally, the media directory listing logic 224 outputs information about the set of the tape media 110 read out from the media directory table 223 (step 254). Specifically, the media directory listing logic 224 may read out the bar code information and the time stamp information in the media directory table 223 in order from top to bottom, and output the bar code information and the time stamp information in order of reading.

Referring to FIG. 11, there is shown an example of a screen as a result of the operation of the media directory listing logic 224 shown in FIG. 10. In the screen, the bar code information and the time stamp information are listed as media directories in response to “dir” command. Note that, also in FIG. 11, it is assumed that the tape media “YAM001” to “YAM010” are inserted in the tape library 100, and the tape media “YAM002” and “YAM007” are mounted on any of the tape drives 120.

In practical implementation, it is possible that a request to access a tape medium is made, and thereby a request to mount the tape medium is made, during update of the media directory table 223 of FIG. 9. In this case, the media directory listing logic 224 may suspend the mount of the tape medium until the update of the media directory table 223 is finished. Alternatively, the media directory listing logic 224 may recreate the media directory table 223 after the response to the request to mount the tape medium.

FIG. 11 shows an example of how a computer-implemented method (see FIG. 10 and associated discussion herein) for listing storage media where mounted and unmounted tape mediums are listed separate and apart from each other rather than being visually presented so that mounted and unmounted tape mediums are intermingled with each other in a single list. More specifically, in the list of FIG. 11: (i) the two mounted tape mediums (YAM0002 and YAM0007) are listed first, as the first two items in the directory listing; and (ii) the eight unmounted tape mediums are listed after all the mounted tape drives have been listed as the third to tenth items in the larger list; and (iii) the mounted and unmounted storage media are therefore presented to a user in a non-intermingled listing. More specifically, in this example, the listing of the unmounted storage media is made after the listing of the mounted storage media.

In the foregoing explanation, the present invention has been applied to LTFS LE for a tape library including N tape drives and M tape media. However, the present invention may also be applied to a file system for an automatic disc changer including one disc player and multiple disc media. This is an alternative embodiment of the present invention in which N is set to 1, M is set to an integer not less than 2, and disc media are used instead of tape media. In this case, one disc medium mounted on the disc player is listed on the top row, and other disc media not mounted on the disc player are listed on the following rows. Further, the present invention may be applied to file systems for other types of storage media libraries including storage drives and storage media.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for use with a file system for a storage media library including a plurality of storage drives and a plurality of storage mediums, where all of the storage mediums are respectively either mounted on a storage drive or unmounted with respect to the storage drives, at least one storage medium is mounted on a storage drive, at least one storage medium is unmounted with respect to the storage drives, the method comprising:
determining a set of mounted storage medium(s) of the plurality of storage mediums that are respectively mounted on a storage drive;
determining a set of unmounted storage medium(s) of the plurality of storage mediums that are respectively unmounted with respect to the storage drive; and
generating a machine readable display data set corresponding to a directory listing of the plurality of storage mediums where the set of mounted storage medium(s) are not intermingled with the set of unmounted storage medium(s) in the directory listing.

2. The method of claim 1 further comprising:
displaying, on a display device, the directory listing based on the machine readable display data set.

3. The method of claim 1 wherein the generation of the machine readable display data set is performed so that the storage medium(s) of the set of mounted display medium(s) appear in the directory listing ahead of the storage medium(s) of the set of mounted display medium(s).

4. The method of claim 3, further comprising:
accessing a set of mounted file(s) from one or more storage medium(s) of the set of mounted storage medium(s); and
on condition that the mounted set of file(s) has been completed, accessing a set of unmounted file(s) from one or more storage medium(s) of the set of unmounted storage medium(s).

5. The method of claim 1 wherein:
the storage media library is a tape storage medium library;
the plurality of storage drives are tape drives; and
the plurality of storage mediums are tape mediums.

6. The method of claim 5, wherein a file system for the storage media library is LTFS LE (Linear Tape File System Library Edition).

7. A computer program product for use with a file system for a storage media library including a plurality of storage drives and a plurality of storage mediums, where all of the storage mediums are respectively either mounted on a storage drive or unmounted with respect to the storage drives, at least one storage medium is mounted on a storage drive, at least one storage medium is unmounted with respect to the storage drives, the computer program product comprising a computer readable storage device having stored thereon:
first instructions executable to determine a set of mounted storage medium(s) of the plurality of storage mediums that are respectively mounted on a storage drive;
second instructions executable to determine a set of unmounted storage medium(s) of the plurality of storage mediums that are respectively unmounted with respect to the storage drive; and
third instructions executable to generate a machine readable display data set corresponding to a directory listing of the plurality of storage mediums where the set of mounted storage medium(s) are not intermingled with the set of unmounted storage medium(s) in the directory listing.

8. The computer program product of claim 7 wherein the computer readable storage device further has stored thereon:
fourth instructions executable to display, on a display device, the directory listing based on the machine readable display data set.

9. The computer program product of claim 7 wherein the third instructions generate the machine readable display data set so that the storage medium(s) of the set of mounted display medium(s) appear in the directory listing ahead of the storage medium(s) of the set of mounted display medium(s).

10. The computer program product of claim 9 wherein the computer readable storage device has further stored thereon:
fourth instructions executable to access a set of mounted file(s) from one or more storage medium(s) of the set of mounted storage medium(s); and
fifth instructions executable to, on condition that the mounted set of file(s) has been completed, access a set of unmounted file(s) from one or more storage medium(s) of the set of unmounted storage medium(s).

11. The computer program product of claim 7 wherein:
the storage media library is a tape storage medium library;
the plurality of storage drives are tape drives; and
the plurality of storage mediums are tape mediums.

12. The computer program product of claim 11, wherein a file system for the storage media library is LTFS LE (Linear Tape File System Library Edition).

13. A computer system for use with a file system for a storage media library including a plurality of storage drives and a plurality of storage mediums, where all of the storage mediums are respectively either mounted on a storage drive or unmounted with respect to the storage drives, at least one storage medium is mounted on a storage drive, at least one storage medium is unmounted with respect to the storage drives, the computer system comprising:
a processor(s) set; and
a computer readable storage device;
wherein:
the processor set is structured, located, connected and/or programmed to run machine readable instructions stored on the computer readable storage device; and
the machine readable instructions include:
first instructions executable to determine a set of mounted storage medium(s) of the plurality of storage mediums that are respectively mounted on a storage drive;
second instructions executable to determine a set of unmounted storage medium(s) of the plurality of storage mediums that are respectively unmounted with respect to the storage drive; and
third instructions executable to generate a machine readable display data set corresponding to a directory listing of the plurality of storage mediums where the set of mounted storage medium(s) are not intermingled with the set of unmounted storage medium(s) in the directory listing.

14. The computer system of claim 13 wherein the machine readable instructions further include:
fourth instructions executable to display, on a display device, the directory listing based on the machine readable display data set.

15. The computer system of claim 13 wherein the third instructions generate the machine readable display data set so that the storage medium(s) of the set of mounted display medium(s) appear in the directory listing ahead of the storage medium(s) of the set of mounted display medium(s).

16. The computer system of claim 15 wherein the machine readable instructions further include:
fourth instructions executable to access a set of mounted file(s) from one or more storage medium(s) of the set of mounted storage medium(s); and
fifth instructions executable to, on condition that the mounted set of file(s) has been completed, access a set of unmounted file(s) from one or more storage medium(s) of the set of unmounted storage medium(s).

17. The computer system of claim 13 wherein:
the storage media library is a tape storage medium library;
the plurality of storage drives are tape drives; and
the plurality of storage mediums are tape mediums.

18. The computer system of claim 17, wherein a file system for the storage media library is LTFS LE (Linear Tape File System Library Edition).
